(19) United States
(12) Patent Application Publication
(10) Pub. No.: US 2018/0078348 A1
(43) Pub. Date: Mar. 22, 2018

(54) METHOD FOR PRODUCING A PARTIAL OR TOTAL PROSTHESIS, AND PROSTHESIS OBTAINABLE BY THIS METHOD

(71) Applicant: KULZER GMBH, Hanau (DE)

(72) Inventors: Klaus RUPPERT, Maintal (DE); Christian BAUER, Schöllkrippen (DE)

(73) Assignee: KULZER GMBH, Hanau (DE)

(21) Appl. No.: 15/560,781

(22) PCT Filed: Mar. 22, 2016
(86) PCT No.: PCT/EP2016/056252

§ 371 Date: Sep. 22, 2017

(30) Foreign Application Priority Data
Mar. 24, 2015 (DE) 10 2015 104 394.7

(51) Int. Cl. A61C 13/00; A61C 13/34; A61C 13/15; A61C 5/77; A61C 13/08; A61C 13/107; A61C 13/09

(52) U.S. Cl. CPC A61C 13/0004; A61C 13/34; A61C 13/0013; A61C 13/0019; A61C 13/081; A61C 5/77; A61C 13/082; A61C 13/0001; A61C 13/09; A61C 19/003

(57) ABSTRACT

The invention relates to a method for the production of a dental prosthetic moulded part, such as a partial or total prosthesis, which is produced in a multilayered manner from a generatively produced solid body model of at least one prosthetic tooth or of a prosthetic dental arch, wherein, inside, tooth neck-sided, the prosthetic teeth have a lumen, in which a dentin-hued, polymerisable composition is filled. The composition is subsequently polymerised in at least one step. The at least one prosthetic tooth with dentin-hued composition is arranged, with its cervical side, on the tooth-sided surface of the denture base and compacted. Subsequently, the partial or total prosthesis obtained is completely cured in a light curing device. The prosthetic moulded parts obtainable according to the method according to the invention are also a subject matter of the invention.

The invention relates to a method for the production of a dental prosthetic moulded part, such as a partial or total prosthesis, which is produced in a multilayered manner from a generatively produced solid body model of at least one prosthetic tooth or of a prosthetic dental arch, wherein, inside, tooth neck-sided, the prosthetic teeth have a lumen, in which a dentin-hued, polymerisable composition is filled. The composition is subsequently polymerised in at least one step. The at least one prosthetic tooth with dentin-hued composition is arranged, with its cervical side, on the tooth-sided surface of the denture base and compacted. Subsequently, the partial or total prosthesis obtained is completely cured in a light curing device. The prosthetic moulded parts obtainable according to the method according to the invention are also a subject matter of the invention.

Besides handwork techniques, digital manufacturing methods more and more gain in importance in dental field. Dental prostheses, such as, for example crowns or bridges, are subtractively produced in milling processes by means of CAD-CAM technology for some years.

Furthermore, generative methods such as SLS (selective laser sintering) of metal powders and SLM (selective laser melting) of plastic powders for the production of crowns, bridges and models, as well as stereolithography for dental products on polymer basis such as, for example, temporary appliances, prostheses, orthodontic apparatus, occlusal splints, surgical guides or dental models, more and more gain in importance.

In this context, the production of dental prostheses on acrylate basis by means of RP methods is still subject to strong restriction up to now. Multicoloured dental prosthesis or dental prostheses made of different polymer materials (e.g. for enamel and dentin masses) for the production of high-quality and aesthetic dental prostheses is only producible up to now by means of complex RP machines having several material chambers or by means of complex gluing and joining techniques.

DE102011102095A1 discloses the production of multi-part prostheses, wherein the at least two, in particular 3+n individual components, connectable with each other by at least one contact surface, are produced by means of generative method. Thus, DE102011102095A1 discloses protheses produced by joining the mentioned, at least two or more generatively produced, adjacent individual components. A disadvantage of these generatively produced, adjacent individual parts is that these individual parts must be manufactured extremely exactly in order to avoid internal surfaces in the prostheses. Such internal surfaces, not equated to internal interfaces, can occur after shrinkages or by warping after the generative production. Said internal surfaces or also cracks impair the aesthetic of translucent materials, as well as the stability, as well as the hygiene of the prostheses.

DE102007010624A1 discloses a method for stereolithographic production of a moulded part from at least two different solidifyable masses, in which layers of the solidifyable masses are solidified on the bottom side of a carrier being immersable into the masses. For performing the time-consuming method, a complex device having a specific container arrangement is used.

The object was to provide an economical method allowing the production of high-quality and very aesthetic dental prostheses by means of a generative method, such as rapid prototyping. Moreover, the object was to simplify the method and to shorten the method duration. In addition, the object was to provide high-quality, aesthetic dental prostheses having an aesthetic as well as translucency similar to tooth enamel, as well as reproducing a dentin-hued core corresponding to a natural tooth. Preferably, an economical method shall enable the production of multilayered or multicoloured prosthetic teeth.

The objects were solved by a method according to claim 1 as well as by the prosthetic moulded part, in particular the partial or total prosthesis, according to claim 12.

Surprisingly, a method could be developed, enabling the production of parts of the prosthesis cost-effectively and efficiently by means of rapid prototyping methods in combination with classical processing of polymerisable dental compositions.

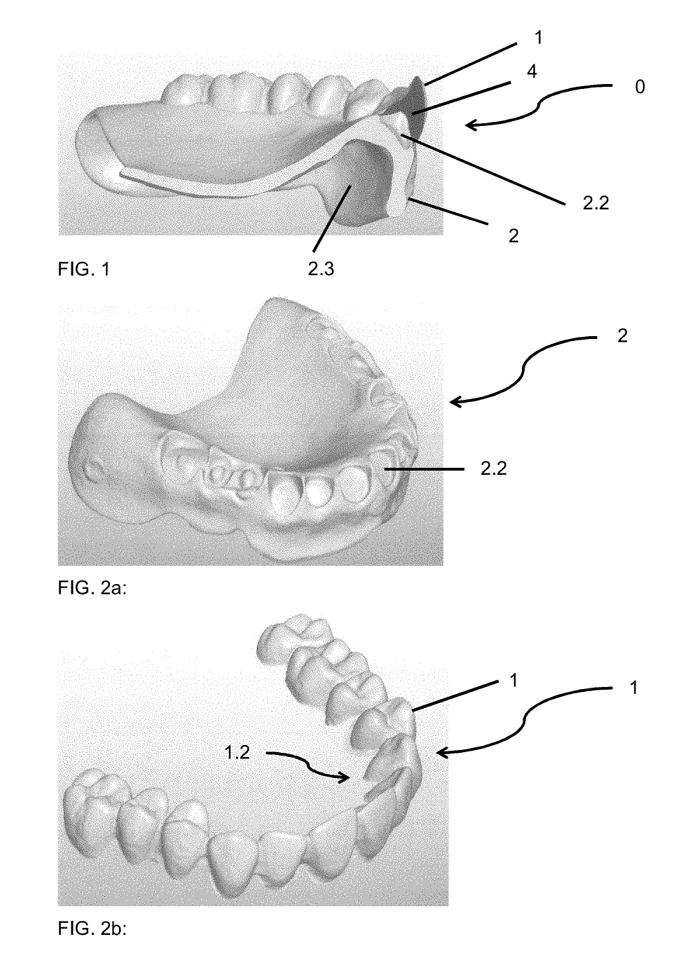

According to the invention, the objects are solved by digitally constructing the total or partial prosthesis at first, such as shown in FIG. 1. Subsequently, the prosthesis is disassembled into a part for the denture base plate, see, for example, FIG. 2a, and into a part for the prosthetic teeth, see FIG. 2b, by means of file splitting (splitting of the digital data).

Due to the software (state of the art), the dataset of the prosthetic teeth having an implied cutting edge is an open mantle (consisting of surfaces 1 only) at first and may be referred to as open surface mantle. Said surface having an opening, synonymously lumen, towards the denture base plate is shown, for example in FIG. 1.

The mere surface mantle—synonymously to digital data of the model of the surface—consists of a connection of points describing the geometry. The points of a point cloud are digitally so connected as to be forming triangles. Thus, a surface consisting of variously sized triangles is obtained. The size of the triangles adapts to the geometry, there is therefore no standard size of the triangles. The wall thickness of the surface mantle is, since digitally developed, equal to zero, i.e. the surface mantle has a wall thickness of 0 mm.

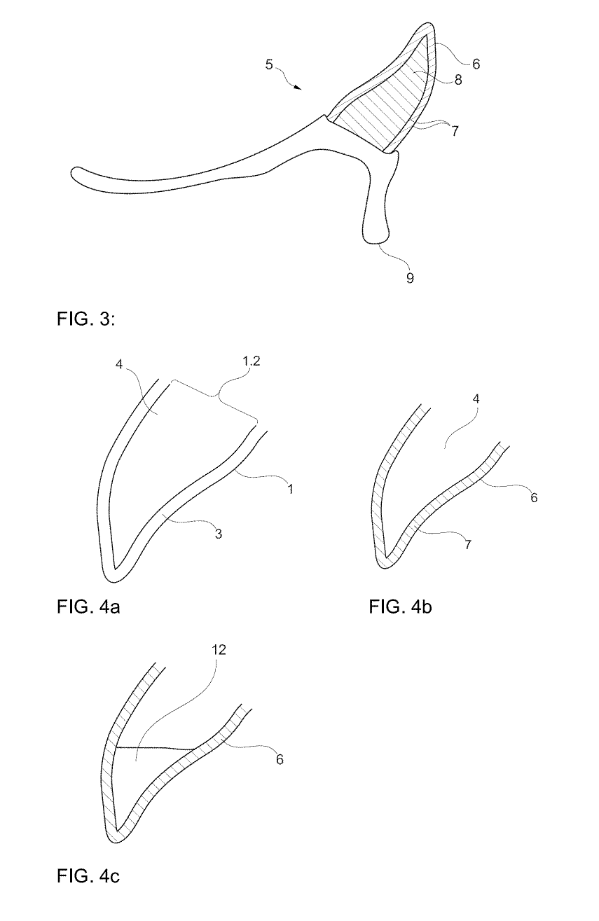

A solid body model is generated from the mere surface mantle—the digital data of the model of the surface—of the prosthetic teeth using appropriate software (FIG. 4a). This is done by extending the digital data of the surfaces (2-dimensional) into the 3rd space (3-dimensional—so called 3D model). This is hereinafter referred to as “wall thickness”.

The wall thickness is determined during the constructive assembly of the partial/total prosthesis and renders the aesthetic tooth shade. Preferred wall thicknesses are in the range of 0.005 mm up to the tooth centre, for example, of 0.005 mm-5 mm. According to the second alternative, a prosthetic tooth is obtained without internal lumen (synonymously: cavity) for filling a dentin-hued, dental composition. This solid body model is subsequently disassembled into parallel layers by means of software, as required in subsequent printing process. Preferably, the solid body model is sliced in the software into parallel layers having a respective layer thickness of approx. 5 to 200 μm. The prosthetic teeth may preferably be produced by means of rapid prototyping methods (RP methods) from at least one or several light-curing material being colour-similar to tooth enamel. For economical production, the individual teeth are preferably connected in a dental arch and simultaneously printed. For very high-quality partial/total prosthesis, the teeth may essentially be printed individually, preferably being at least cervically interconnected.

Likewise, the denture base (plate) may be produced by means of a generative method, such as the RP method. The denture base is produced from a gingiva-hued polymerisable, dental composition.

Particularly preferably, the cavity, synonymously lumen, of the produced tooth or the recesses of the dental arch produced, respectively, is completely filled with one or several flowable, dentin-hued, light-curing, dental compositions. Curing may be ensued either layer by layer or in one step for all layers at the same time—except for the last layer.

Subsequently, the cavity, synonymously lumen, of the prosthetic tooth or of the prosthetic teeth of the dental arch, filled with the uncured and optionally cured composition, is compacted with the denture base plate, possibly waste or overflowing, light-curing composition may thereby be removed. The compacted denture base and the dental arch may subsequently be cured in a light curing device. In doing so, the denture base must be either have a dispersion layer or the surface has previously been activated by e.g. Palabond. During said curing, all components are permanently glued together without marginal gaps and, at the same time, the final strength of the prosthetic material is ensued.

This post-tempering (post-curing) or gluing, respectively, ensues with intensive light in a wave length adjusted to the respective photo initiators, e.g. at 385 nm (Lucirin TPO) or at approx. 100-600 nm (camphorquinone). An appropriate light curing device is, for example, the laboratory light HiLite power of Heraeus Kulzer GmbH.

Stereolithography or DLP methods (method for curing liquid monomers by means of UV- or visible light) are preferred as RP method for the production of the partial/total prosthesis according to the invention. Further conceivable generative or additive production methods, respectively, for the production of the dental prostheses and denture base plate comprise laser sintering or 3D printing, such as fused deposition modeling.

Therefore, subject matter of the invention is a method for the production of a dental prosthetic moulded part, such as a total or partial prosthesis, prosthetic tooth or dental arch, as well as the respective prosthetic moulded parts obtainable according to the method, comprising at least one prosthetic tooth or prosthetic teeth, which are preferably connected in a dental arch, and a denture base (plate), in which
(A) 1. (i) the digital data of the virtual model of the surface of the at least one prosthetic tooth and/or prosthetic teeth are provided, wherein the surface of the at least one prosthetic tooth forms an internal lumen and/or the surface of the prosthetic teeth, each independently, forms a lumen or to a joint lumen, in particular the internal lumen may partially or completely extend over the inner dental arch, and
   1. (ii)—the digital data of the virtual model of the surface of the denture base (plate) are provided, or
   2. (i) the digital data of a virtual model of the surface (STL file) of the moulded part comprising the at least one prosthetic tooth and/or the prosthetic teeth, in particular as dental arch, as well as the denture base are provided, or
   2. (ii) the digital data of the virtual model of the surface are split (file splitting)
      into the digital data of the virtual model of the surface of the at least one prosthetic tooth or of the prosthetic teeth,
         wherein the surface of the at least one prosthetic tooth forms an internal lumen and/or the surface of the prosthetic teeth, each independently, forms a lumen or to a joint lumen, in particular the internal lumen may partially or completely extend over the inner dental arch, and
         into the digital data of the virtual model of the surface of the denture base, and (iii) the digital data of the virtual model of the surface of the at least one prosthetic tooth and/or the surface of the prosthetic teeth, having an internal lumen are converted, in particular by means of a computer software, into digital data of a virtual solid body model based on the data of the virtual model of the surface of the at least one prosthetic tooth, by calculating a defined wall thickness at the inside of the surface of the prosthetic tooth or of the prosthetic teeth inside the virtual model of the surface, and the virtual solid body model of the at least one prosthetic tooth or of the prosthetic teeth, in particular so that the internal Lumen 4 decreases, is obtained, and, optionally,
   (iv) the virtual solid body model of the at least one prosthetic tooth or of the prosthetic teeth, in particular of the dental arch, is digitally disassembled into parallel layers (slices, slicing), wherein, in particular, digital data of the layers for performing the generative method (x,y,z-data) are obtained,
   (v) the digital data of the virtual model of the surface of the denture base (plate) of step (ii) are available as data of a virtual model having an enclosed/self-contained surface or are enclosed in area (2.2), or an enclosed surface is generated in the at least one area, in which the virtual model of the at least one prosthetic tooth or of the prosthetic teeth and the virtual model of the denture base have been split, and, optionally,
   (vi) the virtual model of the denture base is digitally disassembled into parallel layers, wherein, in particular, the digital data of the layers for performing the generative method (x,y,z-data) are obtained,
   (vii) performing step combinations (iii) and (iv) or (v) and (vi) in the order of (iii), (iv), (v) and (vi) or (v), (vi), (iii) and (iv),
(B) (viii) each independently, producing the at least one prosthetic tooth or the prosthetic teeth, in particular the dental arch, as well as the denture base in a generative or additive method, respectively,
   (ix) joining the at least one prosthetic tooth or the prosthetic teeth, in particular the dental arch, and the denture base into a dental prosthetic moulded part, such as a total or partial prosthesis, and
   (x) obtaining the dental prosthetic moulded part having at least one prosthetic tooth and a denture base (plate).

The virtual model of the surfaces of the teeth and the denture base may be generated by means of a computer program and provided as digital data according to known methods of state of the art.

The (A) (i) digital data of the virtual model of the surfaces (STL file) of the moulded part may be captured and/or created in a known manner. For example, by scanning a partially edentulous or totally edentulous jaw, an impression or a model with or without teeth. The digital teeth may be used from a digital library for generating the digital data of a virtual model of the surfaces (STL file) of the moulded part or the digital data of the model of the prosthetic teeth, for example, in order to adjust the cervical area of the prosthetic teeth.

Subsequent to capturing, creating or providing the data of the surface of the moulded part comprising the at least one prosthetic tooth, the digital data of the virtual model of the surface are split (file splitting). Alternatively, the digital data of the models of the prosthetic teeth and of the denture base plate are available in isolation and are individually adjusted in cervical and tooth-sided areas.

The layers according to the invention correspond to slices of a defined layer thickness. The layers or slices, respectively, are obtained by so-called slicing. The layers according to the invention comprise slices, such as, for example, in DLP methods, as well as layers which are obtained by a deposition of pathes, such as in FDM method.

Subsequent to file splitting, an open lumen arises for the virtual model of the surface of the at least one prosthetic tooth, of the prosthetic teeth, or of the dental arch, at the contact area towards the prosthetic base plate, which may be closed by re-adding the denture base plate.

The virtual model of the denture base is calculated as solid body model 10 and digitally disassembled into parallel layers.

Likewise, the surface of the denture base plate has an opening in the area in which the virtual, at least one prosthetic tooth, the prosthetic teeth or the dental arch are cut off after file splitting, which will be closed in the virtual model of the denture base. Moreover, the virtual model of the denture base is calculated as solid body model and, preferably, subsequently sliced into parallel layers providing the data for the RP method. For printing process, the digital data are referenced and the volume shrinkage is considered.

The digital data of the virtual model of the surface of the denture base (plate) available in step (v) exhibit, preferably in said at least one area in which the virtual model of the at least one prosthetic tooth or of the prosthetic teeth, in particular of the dental arch, is inserted, a form-fitting fit and/or a firmly bonded/substance-to-substance bond fit to the cervical, lower and/or inner surface of the solid body model in the area of the respective tooth neck of the at least one prosthetic tooth or dental arch. Particularly preferred, the cervical area of at least one prosthetic tooth 1.2 corresponds to a negative of the corresponding tooth-sided area 2.2 of the denture base plate being formed as positive. According to the invention, all areas 1.2 and 2.2 are individually provided as negative and positive for all teeth. According to a particularly preferred embodiment, all cervical areas of the prosthetic teeth 6 (1 to n) are therefore individually adjusted to a tooth-sided area 2.2 (1 to n) of the outer surface of the denture base plate. In this way, all prosthetic teeth are specifically assigned to an edentulous area of the denture base plate in a defined manner, thus an encoding in the kind of key/lock occurs. Consequently, the connection points of prosthetic tooth and denture base plate in the form of recesses and correspondingly shaped counterpieces are preferably available as unambiguous fit.

During generation of the virtual solid body model of the at least one prosthetic tooth or of the dental arch having defined wall thickness, the external dimension of the surface is not modified. The wall thickness only expands inwards into the inside of the teeth and reduces the lumen or the cavity, respectively, inside the surface, optionally up to zero, i.e. a solid body model whose surface in the area of the tooth neck corresponds to a negative of the surface of the denture base.

In step B, the real/material models of the prosthetic teeth and the denture base are produced.

Preferably, the digital model of the denture base may be converted into a solid body model in step (v), before performing step (vi). Alternatively, after performing step (vi), the digital model of the denture base may be converted into all-over layers during or subsequent to disassembly into layers. Conversion into printing pathes is also conceivable. The production according to the invention preferably ensues in a RP method in which, at the same time, a whole layer of the polymeric composition is polymerised.

In step A (iii), a wall thickness of greater than or equal to 0.005 to 3 mm, in particular of greater than or equal to 0.025 mm, is preferably generated in the virtual solid body model, in particular of 0.025 mm up to a solid body model without internal lumen, wherein the cervical, inner surface of the solid body model, in the area of the respective tooth neck, corresponds to a negative of the tooth-sided, outer surface of the denture base. Preferred wall thicknesses are at 0.05 to 5 mm, preferably from 0.075 to 2.5 mm. Depending on the embodiment, the lumen may be provided in one prosthetic tooth, in each prosthetic tooth a lumen each, or a joint lumen over all prosthetic teeth in a dental arch. In the case where particularly aesthetic, high-quality prostheses shall be produced, one lumen is preferably provided per prosthetic tooth in the anterior tooth area, whilst a joint lumen may exist in the other teeth of the dental arch. For the production of particularly cost-efficient prostheses, the dental arch of the prosthetic teeth may also have a single lumen. The person skilled in the art knows that any conceivable combination according to the method according to the invention may be produced and is obtainable. Therefore, prosthetic teeth and dental arches having the afore-mentioned wall thicknesses are also a subject matter of the invention.

Furthermore, the virtual solid body model obtained in the method according to the invention in step (iii) has a lumen whose dimensions depend, in particular, on the wall thickness.

The wall thicknesses produced in the generative method of the generatively produced at least one prosthetic tooth, of the prosthetic teeth and/or of the dental arch preferably are greater than or equal to 0.025 mm, preferably 0.05 mm to 5 mm, further preferably 0.075 mm to 2 mm or up to a solid body without internal lumen, wherein the cervical, inner surface of the solid body, in the area of the respective tooth neck, corresponds to a negative of the tooth-sided, outer surface of the denture base. According to an alternative, the dental arch over at least two prosthetic teeth has a joint lumen. Preferably, the prosthetic teeth of the anterior tooth area respectively have one lumen.

According to a particularly preferred alternative, two or more prosthetic teeth constitute a virtual solid body model by being connected, each approximally, and forming at least one part of a dental arch, in particular 2 to 16 teeth form, each approximally connected, a dental arch as virtual solid body model of an upper or lower jaw.

According to the method according to the invention, two or more of the generatively produced prosthetic teeth are approximally connected and form at least a part of a dental arch, in particular 2 to 16 teeth are produced forming, each approximally connected, a dental arch of an upper or lower jaw. Subject matter of the invention is a dental arch obtainable according to the method.

The digital layers of the prosthetic teeth, the dental arch and/or the denture base (plate) preferably have a layer thickness (z-data) of 5 to 200 μm, in particular a layer thickness of 25 to 200 μm, further preferably of 25 to 100 μm, particularly preferably of 25 to 50 μm.

The production of the prosthetic moulded parts, such as of the prosthetic teeth, i.e. of the prosthetic teeth having a lumen and/or of the denture base plate preferably ensues in a generative method, comprising photochemical polymerisation (radiation curing), stereolithography and/or 3D printing. In a particularly preferred embodiment, the production ensues in a generative method with homogenised distribution of light intensity with a spatial light modulator, such as a rapid prototyping method, in which the distribution of light intensity is homogenised by homogenised distribution of light intensity, in particular by a LED data projector comprising a homogenised distribution of light intensity, such as disclosed in DE102012224005A1. According to this method, a whole layer of the polymerisable composition, e.g. of the at least one prosthetic tooth, of the denture base, may be polymerised by exposure step or exposure flash, respectively. Besides UV/VIS lasers, UV/VIS-LED data projectors, ultraviolet-(UV) lasers, UV-LED data projectors may also be used as well as LED data projectors having longer-wavelength light, i.e. 420-430 nm.

The method according to the invention preferably comprises one step of generative production of the prosthetic tooth, the prosthetic teeth, the dental arch and/or the denture base plate, wherein a photochemical polymerisation of a liquid composition comprising monomers and/or polymers activated by a light source is ensued. A data projector or a laser system, in particular having a wave length of 100 to 600 nm, preferably of 180 to 440 nm, is preferably used as light source, preferably a LED data projector having a radiation about 385 nm or 430 nm, respectively, is used or laser system having a radiation having a wave length between 220 to 440 nm.

Another subject matter of the invention is a method, in which

a) from the virtual solid body model having a lumen, at least one prosthetic tooth having a lumen or prosthetic teeth, in particular a dental arch, having at least one lumen up to respectively one lumen per tooth are produced in a generative method, or
b) from the virtual solid body model optionally comprising at least one prosthetic tooth having a lumen up to a solid body model, in which the at least one prosthetic tooth is available without internal lumen, wherein the surface of said solid body model, in the cervical area of the respective tooth neck of the prosthetic teeth, in particular of the dental arch, without internal lumen corresponds to a negative of the tooth-sided outer surface of the area of the denture base, and
at least one of said prosthetic tooth or prosthetic teeth, in particular of said dental arch, are produced in a generative method.

Another subject matter of the invention is a method, in which in a method step (B), after performing step (viii)
the at least one prosthetic tooth having a lumen or the prosthetic teeth, in particular a dental arch, having at least one lumen up to respectively one lumen per tooth, the said at least one lumen is filled up, at least in part, with at least one or several flowable, dentin-hued, polymerisable, dental compositions in one or several steps, optionally, the dental composition is polymerised at least in part, and in a further method step ensues
   (ix) joining the at least one prosthetic tooth or the prosthetic teeth, in particular the dental arch, and the denture base into a dental prosthetic moulded part, such as a partial or total denture, by joining together the at least one prosthetic tooth or the prosthetic teeth with their cervical area to the corresponding tooth-sided areas of the denture base, and
   (x) the dental prosthetic moulded part of a partial or total prosthesis is obtained. In this context, it is particularly preferred for the composition in the partial or total denture to be further polymerised by means of UV- and/or VIS-light after mating together.

The partial polymerisation may be ensued after step (B) (vii) and bevor performing step (ix).

The at least one lumen is filled up, preferably at least in part, with at least one or several flowable, dentin-hued, UV-VIS-polymerisable, dental compositions and polymerised by UV- and or VIS-light in one or several steps. Filling up may be ensued in one step, in several steps, such as, for example in 1 to 20 steps, wherein polymerising the composition(s) may also be ensued one time or several times.

Joining in the method according to the invention preferably ensues (ix) by

a) mating together and, subsequently, the dentin-hued, dental composition is polymerised, or
b) gluing together, c) melting together, d) welding together and/or
e) shrinking together
the at least one prosthetic tooth or the prosthetic teeth, in particular a dental arch, and the denture base into a dental prosthetic moulded part.

According to a particular preferred method step of the method ensues (a) filling a polymerisable, dental, in particular flowable, composition in the lumen of the at least one prosthetic tooth or in the lumen/lumens of the prosthetic teeth, in particular of the dental arch, and

(b) polymerising the composition, and, optionally, repeating steps a) and b), and
(c) joining the at least one prosthetic tooth or the prosthetic teeth, in particular the dental arch, in the cervical area, to the corresponding tooth-sided areas of the denture base, or, in particular
(c) joining the at least one prosthetic tooth or the prosthetic teeth, in particular a dental arch, in the cervical area, to the corresponding tooth-sided areas of the denture base and polymerising the composition, wherein the at least one prosthetic tooth or the prosthetic teeth are connected to the denture base by mating and optionally polymerising.

Due to the method according to the invention, automation of the individual method steps up to automation of all method steps may be ensued. In particular, steps (A), (B), partially to completely, in particular (viii) and (ix), preferably (xi) a, b, c, or d, and/or e, may be automated.

Connection of the prosthetic tooth, the prosthetic teeth or the dental arch to the denture base plate ensues, in particular, without marginal gaps.

One or several flowable, dentin-hued compositions are preferably used as polymerisable, dental composition in the method according to the invention, which comprise monomers, in particular di(meth)acrylates, as well as, optionally, fillers, in particular dental glasses. Moreover, the composition preferably has a viscosity of 10² to 10⁶ mPa·s. A viscosity of 10² to 10⁶ mPa·s after 248 sec lasting stress, of 5*10⁵ mPa·s during development of stress and of 10⁶ mPa·s in rest is preferred.

The method according to the invention enables, in a particular manner, an optimal adjustment of the geometry and/or dental colours and/or gingival colours as well as their gradient, gradation in selected areas of the prosthetic restauration in an automated method. In this context, the respective dentin colour may optimally be adjusted to the dental colour of the generatively produced mantle of the dental prosthesis or the dental arch. Therefore, the method according to the invention allows very economical production of partial- or total-prosthetic restaurations in an automated method maintaining highest aesthetical demands for the prosthetic restauration at the same time. In this way, economical adjustment of the dental colours to the remaining teeth may be ensued.

The dental, polymerisable compositions for generative production of prosthetic teeth, the light-curing dentin-hued composition as well as the composition for generative production of the denture base may comprise, for example, the following components. Preferably, a light-curing composition for production of the afore-mentioned prosthesis parts is used.

A typical composition may comprise (a) at least one curable monomer and/or polymer component, and, optionally, (b) at least one filler component. The amount of monomers in the total composition may be up to 100% by weight, from 40 to 99.99% by weight are preferred, in particular 50 to 99.99% by weight or from 98% by weight up to 99.99% by weight, wherein 0.01 to 2% by weight initiator, stabilizers or excipients may be contained.

In this context, a composition may comprise as filler component (b) a total filler content of 10 to 98% by weight, in particular of 60 to 95% by weight, based on the total composition, comprising (b.1) 10 to 35% by weight, in particular 10 to 30% by weight, preferably 10 to 25% by weight, particularly preferably 15 to 25% by weight, in particular silanised oxide particles, and/or (b.2) at least one dental glass of 0 to 75% by weight, in particular of 10 to 65% by weight, particularly preferably of 40 to 60% by weight, such as 45 to 50 or 50 to 65% by weight, wherein preferably a mixture of dental glasses made up of 50 to 90% coarse and 10 to 50% fine dental glasses is used, which have a size ratio, relative to the mean particle size (d50 value), of fine to coarse of 30:1 to 1:30, and, optionally, (b.3) 0.5 to 10% by weight non-agglomerated nano-fillers having particle sizes of 1 to 50 nm.

The amount of (a) monomers in the total composition may be 2 to 90% by weight, in particular 5 to 80% by weight, wherein the composition optionally comprises at least 0.1% by weight initiators, in particular 0.1 to 2% by weight.

One or more monomers from the monomer mixture (i), (ii), and (iii) are preferably selected as (a) curable or polymerisable monomer and/or polymer components for the composition:
(i) at least one monomer from the group of bisglycidylacrylate, alkoxylated pentaerythritol tetraacrylate, TCD-di-HEMA or TCD-di-HEA as well as derivatives thereof, in particular for 2 to 20% by weight, in particular 2 to 10% by weight, based on the total composition, and
(ii) at least 5 to 80% difunctional cross-linker UDMA (diurethane dimethacrylate) and/or aliphatic diacrylate, in particular 25 to 75% by weight, based on the total composition, and
(iii) optionally, residual TEDMA (trimethylene glycol dimethacrylate) and/or further multi-functional cross-linkers, in particular 0 to 15% by weight, preferably 0.01 to 10% by weight or less, based on the total composition,
   wherein, in particular, (i), (ii) and (iii) may be present for a total of 5 to 90% by weight in the dental material, preferably for 50 to 85% by weight, c) up to 1% initiator(s) and, optionally, (b) to 100% at least one filler component are present in the composition, such as silicic acid. Optionally, in addition to polymerisable monomers, particulate, organic polymers may be contained in the total composition to 100% by weight.

Non-agglomerated nano-fillers are generally known and are described, for example, in WO0130305A1 or in DE19617931A1 using SiO₂ as an example. They can preferably be selected from the group SiO₂, ZrO₂, TiO₂, Al₂O₃ as well as from mixtures of at least two of these substances. They can—as described in DE19617931A1—be dispersed in organic solvents, or also be added to water or water-containing solvent mixtures.

Barium glass powders, preferably barium glass-aluminium-borosilicate glasses, and/or strontium glass powders are particularly well-suited as dental glasses. The mean particle size of the coarse dental glasses preferably is 5 to 10 [micro]m (μm), in particular about 7 [micro]m (μm), and the mean particle size of the fine dental glasses 0.5 to 2 [micro]m (μm), in particular 1 [micro]m (μm). Further dental glasses optionally being present have mean grain sizes, for example, of 2-5 or 10-50 [micro]m (μm).

Accordingly, the filler component may comprise dental glasses having a total of three or more grain fractions. It may also contain further, conventional, fillers customary in dental field, such as quartz ceramics, glass ceramics or mixtures thereof. Moreover, the composites may comprise fillers for attaining an increased radiopacity.

The dental material preferably comprises the following monomers or polymers as curable monomer and/or polymer component:

Monomers common in dental field are conceivable as monomers: Examples include radically polymerisable monomers such as mono(meth)acrylates, methyl-, ethyl-, butyl-, benzyl-, furfuryl- or phenyl(meth)acrylate, poly-functional monomers such as poly-functional acrylates or methacrylates, e.g. bisphenol-A di(meth)acrylate, bis-GMA (an addition product of methacrylic acid and bisphenol-A diglycidylether), UDMA (urethane dimethacrylate), e.g. an addition product of 2-hydroxyethylmethacrylate and 2,2,4-hexamethylene diisocyanate), di-, tri- or tetraethylene glycol di(meth)acrylate, decanediol di(meth)acrylate, dodecanediol di(meth)acrylate, hexyldecanediol di(meth)acrylate, trimethylol propane tri(meth)acrylate, pentaerythritol tetra(meth)acrylate as well as butanediol di(meth)acrylate. Bis-GMA, TEDMA (triethylene glycol dimethacrylate), UDMA (urethane dimethacrylate), TCD-di-HEMA (bis(methacryloyloxymethyl)tricyclo[5.2.1.02,6]decane) and TCD-di-HEA (bis(acryloyloxymethyl)tricyclo[5.2.1.02,6] decane) are particularly preferred. At least one monomer selected from the following or mixtures thereof can be used as preferred cross-linker monomer: 2,2-bis-4-(3-methacryloxy-2-hydroxypropyl) phenylpropane) (Bis-GMA), i.e. the conversion product of glycidylmethacrylate and bisphenol-A (OH group-containing), and 7,7,9-trimethyl-4,13-dioxo-3,14-dioxa-5,12-diazahexadecane-1,16-diyldimethacrylate (UDMA), i.e. the urethane dimethacrylate from 2 mol 2-hydroxyethylmethacrylate (HEMA) and 1 mol 2,2,4-trimethylhexamethylene diisocyanate (urethane group-containing). Moreover, conversion products of glycidylmethacrylate with other bisphenols, such as, for example, bisphenol-B (2,2′-bis-(4-hydroxyphenyl)butane), bisphenol-F (2,2′-methylene diphenol) or 4,4′-dihydroxydiphenyl, as well as conversion products of 2 mol HEMA or 2-hydroxypropyl(meth)acrylate with, in particular 1 mol, known diisocyanates, such as, for example, hexamethylene diisocyanate, m-xylylene diisocyanate or toluylene diisocyanate, are well-suited as cross-linker monomers.

The following multi-functional cross-linkers are conceivable aside from TEDMA and UDMA: diethylene glycol di(meth)acrylate, decanediol di(meth)acrylate, trimethylol propane tri(meth)acrylate, pentaerythritol tetra(meth)acrylate as well as butanediol di(meth)acrylate, 1,10-decanediol di(meth)acrylate, 1,12-dodecanediol di(meth)acrylate.

The dental material may preferably also comprise the following monomers and/or polymers as curable monomer and/or polymer component: one or more ethylenically unsaturated compounds with or without acid functionality. For example, acrylic acid esters, methacrylic acid esters, hydroxy-functional acrylic acid esters, hydroxy-functional methacrylic acid esters and combinations thereof. As well as, mono-, di- or poly(meth)acrylates, i.e. acrylates and methacrylates, such as methyl(meth)acrylate, ethylacrylate, isopropyl methacrylate, n-hexylacrylate, stearylacrylate, allylacrylate, glycerol triacrylate, ethylene glycol diacrylate, diethylene glycol diacrylate, triethylene glycol dimethacrylate, 1,3-propanediol (meth)acrylate, trimethylol propane triacrylate, 1,2,4-butanetriol trimethacrylate, 1,4-cyclohexanediol diacrylate, pentaerythritol tetra(meth)acrylat, sorbitol hexacrylates, tetrahydrofurfuryl(meth)acrylate, bis[1-(2-acryloxy)]-p-ethoxyphenyldimethylmethane, bis[1-(3-acryloxy-2-hydroxy)]-p-propoxyphenyldimethyl methane, ethoxylated bisphenol-A di(meth)acrylate and trishydroxyethylisocyanurate isocyanurate trimethacrylate, (meth)acrylamides (i.e. acrylamides and methacrylamides), such as (meth)acrylamide, methylene bis(meth)acrylamide and diacetone (meth)acrylamide; urethane (meth)acrylates; the bis(meth)acrylates of polyethylene glycols (preferably having a molecular weight of 200-500 g/mol), co-polymerisable mixtures of acrylated monomers, and vinyl compounds such as styrene, diallylphthalate, divinylsuccinate, divinyladipate and divinylphthalate. Other appropriate radically polymerisable compounds comprising siloxane-functional (meth)acrylates and fluoropolymer-functional (meth)acrylates or mixtures of two or more radically polymerisable compounds may be used if required.

The polymerisable component may also comprise hydroxy groups and ethylenically unsaturated groups in a single molecule. Examples of such materials comprise hydroxyalkyl(meth)acrylates, such as 2-hydroxyethyl(meth)acrylate and 2-hydroxypropyl(meth)acrylate; glycerol mono- or di(meth)acrylate; trimethylol propane mono- or di(meth)acrylate; pentaerythritol mono-, di- and tri(meth)acrylate; sorbitol mono-, di-, tri-, tetra- or penta(meth)acrylate and 2,2-bis[4-(2-hydroxy-3-methacryloxypropoxy)phenyl]propane (BisGMA) or mixtures of ethylenically unsaturated compounds. The curable or polymerisable component may comprise PEGDMA (polyethylene glycol dimethacrylate having a molecular weight of about 400 g/mol), GDMA (glycerol dimethacrylate), TEGDMA (triethylene glycol dimethacrylate) and/or NPGDMA (neopentylglycol dimethacrylate) as well as comprise their mixtures.

The composites comprise a polymerisation initiator for initiation of polymerisation, for example an initiator for radical polymerisation. Depending on the type of initiator used, the mixtures may be cross-linked cold, by radiation, i.e. UV- or VIS-cross-linked, or may be polymerisable through the supply of heat.

Known peroxides, such as dibenzoylperoxide, dilauroylperoxide, tert.-butylperoctoate or tert.-butylperbenzoate, but also alpha, alpha′-azo-bis(isobutyroethylester), benzpinacol and 2,2′-dimethylbenzpinacol, may be used as initiators for temperature-induced polymerisation. The initiators for temperature-induced polymerisation may be used according to the invention for curing of the dentin-hued composition and/or for gluing the prosthetic teeth with the denture base plate.

Conceivable photoinitiators are, for example, benzoinalkylethers or -esters, benzilmonoketals, acylphosphinoxides or aliphatic and aromatic 1,2-diketocompounds, such as, for example, 2,2-diethoxyacetophenone, 9,10-phenanthrene quinone, diacetyl, furil, anisil, 4,4′-dichlorobenzil and 4,4′-dialkoxybenzil or camphorquinone. The photoinitiators are preferably used in conjunction with a reducing agent. Examples of reducing agents include amines such as aliphatic or aromatic tertiary amines, for example N, N-dimethyl-p-toluidine or triethanol amine, cyanoethylmethylaniline, triethylamine, N,N-dimethylaniline, N-methyldiphenylamine, N,N-dimethyl-sym.-xylidine, N,N-3,5-tetramethylaniline and 4-dimethylaminobenzoic acid ethylester or organic phosphites. Common photoinitiator systems include, for example, camphorquinone plus ethyl-4-(N,N-dimethylamino)benzoate, 2-(ethylhexyl)-4-(N,N-dimethylamino)benzoate or N, N-dimethylaminoethylmethacrylate.

2,4,6-Trimethylbenzoyldiphenylphosphinoxide is particularly well-suited as initiator for the UV-light-induced polymerisation. UV-photoinitiators may be used alone, in combination with an initiator for visible light, an initiator for cold curing and/or an initiator for temperature-induced curing.

Radical-forming systems, e.g. benzoyl- or lauroylperoxide, are used in combination with amines such as N,N-dimethyl-sym.-xylidine or N,N-dimethyl-p-toluidine, as initiators for cold polymerisation. Dual-curing systems may be used as well, e.g. photoinitiators with amines and peroxides. The initiators are preferably used in amounts from 0.01 to 1% by weight, based on the total mass of the mixture. The initiators for cold polymerisation may be used according to the invention for curing the dentin-hued composition or for gluing the prosthetic teeth with the denture base plate.

It may be expedient in cold polymerisation for the composite material to be subdivided into two components intended to be cured by mixing. It is also feasible to provide the material appropriately such that it can be cured both by VIS and/or UV light as well as by mixing of two components. The two components of the dentin-hued material may be present in two pastes and as powder/liquid system. The radical initiator system required for polymerisation is divided to the two pastes or is contained in the liquid component (A) and/or the powdered component (B) depending on reaction conditions or polymerisation system, respectively. Pertinent details are known by the person skilled in the art. For example, in base mixtures for cold-cure polymers, the initiator system is most often present in both components, the liquid component and the powdered component, and is thus combined when mixing said components. In base mixtures for hot-cure polymers, the initiator is most often present in the polymer component, i.e. the powdered component. The initiator then only gets to the liquid monomer component when mixing. Accordingly, prosthesis starting materials may be provided in which the initiator component (c) is present in powdered component (B), in particular in the form of peroxides, perketals, peresters and/or azo compounds. This may also be, for example, residual contents of initiator components that did not react during production of the powdered components, e.g. peroxides such as dibenzoylperoxide.

Conceivable initiators for the polymerisation reaction of cold and/or auto-polymerising starting mixtures are basically those that may be used to initiate radical polymerisation reactions. Preferred initiators include peroxides such as dibenzoylperoxide, dilauroylperoxide and di-t-butylperoxide, as well as azo compounds such as Azobis(isobutyronitrile) (AIBN).

Accordingly, LPO: dilauroylperoxide, BPO: dibenzoylperoxide, t-BPEH: tert-butylper-2-ethylhexanoate, AIBN: 2,2′-azobis(isobutylnitrile), DTBP: di-tert.-butylperoxide are conceivable.

Appropriate activators, e.g. aromatic amines, may be added to accelerate the initiation of radical polymerisation through peroxides. Exemplary, N,N-dimethyl-p-toluidine, N,N-dihydroxyethyl-p-toluidine, and p-dibenzylaminobenzoic acid diethylester are to be mentioned as appropriate amines. In this context, the amines usually function as co-initiators and are usually present in an amount of up to 0.5% by weight, based on the total composition.

Redox systems, in particular combinations of dibenzoylperoxide, dilauroyl or camphorquinone with amines such as N,N-Dimethyl-p-toluidine, N—N-Dihydroxyethyl-p-toluidine and p-Dimethylaminobenzoic acid diethylester, are also well-suited as radical initiator systems. Furthermore, redox systems also comprising, besides peroxide, ascorbic acid or their derivatives, barbituric acid or a barbituric acid derivative or a sulfinic acid as reduction agent may also be used. In an expedient embodiment, a redox system of this type comprises barbituric acid or thiobarbituric acid, or a barbituric acid or thiobarbituric acid derivative (for example 0.01-10% by weight), at least one copper salt or copper complex (for example 0.1 to 8% by weight), and at least one compound having an ionogenic halogen atom (for example 0.05 to 7% by weight), each in relation to the content of initiator system of 0.01 to 1% by weight, based on the total composition. Exemplary, 1-benzyl-5-phenylbarbituric acid, copper acetylacetonate and benzyldibutylammonium chloride are to be mentioned as appropriate ingredients of the afore-mentioned redox system.

Curing of the compositions preferably ensues through redox-induced radical polymerisation at room temperature or at slightly elevated temperature, respectively, and under a slight pressure in order to avoid the formation of bubbles. For example barbituric acids in conjunction with copper and chloride ions are used as initiators for polymerisation performed at room temperature. A particularly preferred initiator system consists of a combination of. Said system is characterised by its high level of colour-stability.

Preferably, the liquid composition for generative production of the at least one prosthetic tooth comprises at least one monomer, in particular at least one di(meth)acrylate, the compositions particularly preferably comprises UDMA, ethoxylated bisphenol-A and, optionally, dental glasses, as well as pyrogenic silica.

Preferably, the generatively produced prosthetic tooth (6) has a translucency of >50%. Particularly preferably, the polymerised dentin-hued, dental composition has a translucency of greater than or equal to 35% and/or the at least one generatively produced prosthetic tooth or the dental arch has a translucency of greater than or equal to 55 to 65%.

Preferably, the liquid composition for generative production of the denture base (plate) comprises at least one monomer, in particular at least one di(meth)acrylate and, optionally, fillers such as, for example, dental glasses with d₅₀<2 μm, and, optionally, pyrogenic silica.

Subject matter of the invention are also prosthetic moulded parts, in particular dental prosthetic moulded parts selected from prosthetic tooth, prosthetic teeth, dental arch comprising prosthetic teeth, denture base (plate) and/or total or partial prosthesis, as well as prosthetic moulded parts comprising temporary prosthetic tooth/teeth, temporary dental arch, temporary denture base plate and/or temporary partial/total prosthesis (each real models).

Another subject matter of the invention is the use of a flowable, dentin-hued, polymerisable, dental composition comprising dental glasses in the method according to the invention.

Furthermore, a subject matter of the invention is the use of a total or partial prosthesis obtainable by the method according to any one of the claims as (i) temporary prosthesis or (ii) as real model of a temporary prosthesis for adjusting the temporary prosthesis to the dental condition of the patient, or (iii) as real model of a temporary prosthesis for adjusting the temporary prosthesis to the dental condition of the patient and for scanning of the thus adjusted temporary prosthesis, as well as, optionally, for adjustment of the virtual model of the at least one prosthetic tooth or the prosthetic teeth, or the dental arch, and the denture base plate for generative production of the total or partial prosthesis of the patient.

The shematic FIGS. 1 to 4 represent an embodiment of the invention without limiting the invention to these embodiments.

FIG. 1 sliced total prosthesis 0 or digital data of the virtual model of the surface 0 of the prosthetic moulded part

FIG. 2a: denture base (plate) 2 after file splitting

FIG. 2b: dental prostheses 1 after file splitting

FIG. 3: sectional view real total prosthesis 5 with prosthetic tooth 6 of a defined wall thickness 7 and a polymerisable composition 8 in lumen 4 joined on a denture base plate 9.

FIG. 4a: sectional view virtual dental prosthesis/es 1 having a defined wall thickness 3/7a and a lumen 4.

FIG. 4b: sectional view real dental prosthesis/es 6 having defined wall thickness 7b and a lumen 4.

FIG. 4c: sectional view of the real dental prosthesis/es 6 which is partially filled up with dentin-hued, unpolymerised composition 12.

### EXAMPLES

FIG. 1 shows a sliced total prosthesis 0 from the digital data of the virtual model of the surface 0 of the prosthetic moulded part. This data set is subsequently split by the software (file splitting) into the digital data of the denture base (plate), which is shown in FIG. 2a as denture base plate 2, and into the digital data of the dental prostheses 1, which are shown in FIG. 2b as surface mantle of the dental prostheses. The cervical area of the prosthetic tooth sits as 1.2 at the tooth neck (bottom side not visible). Furthermore, FIG. 1 shows the supragingival surface 2.3 of the denture base (above the gums).

In FIG. 2a, the crestal area 2.2 is additionally shown in which the virtual model of the at least one prosthetic tooth 1 or the prosthetic teeth 1 and the virtual model of the denture base 2 have been split or, alternatively, the enclosed crestal surface 2.2 in this area. The cervical area 1.2 of the prosthetic tooth is joined in area 2.2, in particular by polymerisation of waste dental composition 12, subsequent to the dental prosthesis and the denture base plate have been compacted.

FIG. 3 shows a sectional view of the produced real total prosthesis 5 with prosthetic tooth 6. The prosthetic tooth has a defined wall thickness 7 and a polymerisable composition 8 in lumen 4. The prosthetic tooth 6 has been joined on a denture base plate 9.

In FIGS. 4a to 4c, various stages of the production of the prosthetic tooth 1 are shown. FIG. 4a shows a cross-section through the virtual model 1 of the tooth of the solid body model 11 having a constructed defined wall thickness 3 and remaining lumen or cavity 4, respectively. The cervical area is represented by 1.2. The real prosthetic tooth 6 having defined wall thickness 7 and a lumen 4 is produced from this solid body model in a stereolitography method, such as shown in FIG. 4b. FIG. 4c shown a further method step, in which the dental, dentin-hued composition 12 is filled in the lumen 4 of the prosthetic tooth 6. The composition 12 may be polymerised and, subsequently, further dental composition 12 may be filled in the lumen. When the lumen is filled, the prosthetic tooth 6 is put on the denture base 9, compacted and polymerised by UV-light. The partial or total prosthesis 5 thus produced may be post-tempered in light oven.

In the following, two typical compositions for the dental, polymerisable composition in the generative method for the production of the dental prostheses 6 and the denture base plate 9 (table 1) and for the dentin-hued composition (table 2) are stated.

TABLE 1
Example for composition base plate + tooth enamel

| | % by weight |
|---|---|
| ethoxylated bisphenol-A dimethacrylate | 4 |
| urethane dimethacrylate | 55 |
| pentaerythritol, propoxylated tetraacrylate | 7 |
| aliphatic dimethacrylate | 16.5 |
| pyrogenic silica | 16 |
| camphorquinone | 0.1 |
| Lucirin TPO | 0.7 |
| tertiary aromatic amine | 0.1 |
| stabilizers | 0.1 |
| UV-absorbers | 0.3 |
| pigments | 0.2 |

TABLE 2
Example for composition dentin-hued composition (flowable)

| | % by weight |
|---|---|
| ethoxylated bisphenol-A dimethacrylate | 25 |
| triethylene glycol dimethacrylate | 12 |
| tertiary aromatic amine | 0.1 |
| dimethoxydiphenylethan-1-on | 0.1 |
| camphorquinone | 0.2 |
| UV-absorbers | 0.3 |
| stabilizers | 0.1 |
| pyrogenic silica | 5 |
| dental glass | 57 |
| pigments | 0.2 |

### LIST OF REFERENCE NUMERALS

0 digital data of the virtual model of the surface of the prosthetic moulded part (surface envelope)
1 surface of the at least one prosthetic tooth (surface mantle)
1.2 cervical area prosthetic tooth (tooth neck)
2 digital data of the virtual model of the surface of the denture base (plate), (surface mantle)
2.2 tooth-sided area, which forms by splitting the virtual model of the at least one prosthetic tooth 1 or the prosthetic teeth 1 and the virtual model of the denture base 2, or, alternatively, the enclosed tooth-sided surface 2.2 in this area
2.3 supragingival surface of the denture base (above the gums, gums-sided surface)
3 defined wall thickness, digital wall thickness in solid body model 11
4 lumen, inside the prosthetic tooth synonymously: cavity, recesses
5 prosthetic moulded part
6 prosthetic tooth or prosthetic teeth
7 wall thickness of the prosthetic tooth/teeth (1/6) (7a: virtual prosthetic tooth/teeth, 7b: real prosthetic tooth/teeth)
8 dentin-hued, polymerised composition in lumen 4,
9 denture base (plate)
10 virtual solid body model of the denture base 2, in particular the solid body model 10 is digitally disassembled into parallel layers, and producing the denture base 9 in a generative method
11 virtual solid body model of the at least one prosthetic tooth, of multiple prosthetic teeth, of the dental arch
12 dentin-hued, unpolymerised composition

1. A method for the production of a dental prosthetic moulded part (5) comprising at least one prosthetic tooth (6) and a denture base (9), in which
(A) 1. (i) the digital data of the virtual model of the surface of the at least one prosthetic tooth (1) are provided, and
(ii) the digital data of the virtual model of the surface of the denture base (plate) are provided, or
2. (i) the digital data of a virtual model of the surface (0) of the moulded part comprising the at least one prosthetic tooth (1) and the denture base (2) are provided,
(ii) the digital data of the virtual model of the surface (0) are split into the digital data of the virtual model of the surface of the at least one prosthetic tooth (1), and
into the digital data of the virtual model of the surface of the denture base (2),
wherein the surface of the respective at least one prosthetic tooth (1) forms an internal lumen, and
(iii) the digital data of the virtual model of the surface of the at least one prosthetic tooth (1) having an internal lumen (4) are converted into digital data of a virtual solid body model (11) based on the data of the virtual model of the surface (1) by calculating a defined wall thickness (3) at the inside of the surface inside the virtual model of the surface of the at least one prosthetic tooth (1) and obtaining the virtual solid body model (11) of the at least one prosthetic tooth (1), and, optionally,
(iv) the virtual solid body model (11) of the at least one prosthetic tooth (1) is digitally disassembled into parallel layers,
(v) the digital data of the virtual model of the surface of the denture base (2) of step (ii) are available as data of a virtual model having an enclosed surface in area (2.2) or are enclosed in area (2.2), or an enclosed surface is generated in the at least one area (2.2), in which the virtual model of the at least one prosthetic tooth (1) and the virtual model of the denture base (2) have been split, and, optionally,
(vi) the virtual model of the denture base (2) is digitally disassembled into parallel layers,
(vii) performing step combinations (iii) and (iv) or (v) and (vi) in the order of (iii), (iv), (v) and (vi) or (v), (vi), (iii) and (iv),
(B) (viii) each independently, producing the at least one prosthetic tooth (6) and the denture base (9) in a generative method,
(ix) joining the at least one prosthetic tooth (6) and the denture base (9) into a dental prosthetic moulded part (5), and
(x) obtaining the dental prosthetic moulded part (5) having at least one prosthetic tooth (6) and a denture base (9).

2. The method according to claim 1, wherein
(i) the wall thickness of the virtual solid body model (11) is at least from 0.005 mm to 5 mm, or
(ii) the solid body model (11) is available without internal lumen (4), wherein the cervical, inner surface of the solid body model (11), in the area of the respective tooth neck, corresponds to a negative of the tooth-sided, outer area (2.2) of the surface of the denture base (2).

3. The method according to claim 1, wherein
two or more prosthetic teeth (1) constitute a virtual solid body model (11) by being connected, each approximately, and forming at least one part of a dental arch.

4. The method according to claim 1, wherein
the digital parallel layers have a layer thickness (z-data) of 5 to 200 μm.

5. The method according to claim 1, wherein the generative method comprises a photochemical polymerisation, stereolithography and/or 3D-printing.

6. The method according to claim 1, wherein
the generative method is based on photochemical polymerisation of a liquid composition comprising monomers and/or polymers activated by a light source.

7. The method according to claim 1, wherein
a) from the virtual solid body model (11) having a lumen (4), at least one prosthetic tooth (6) having a lumen (4) or prosthetic teeth (6) having at least one lumen (4) up to respectively one lumen (4) per tooth are produced in a generative method, or
b) from the virtual solid body model (11) optionally comprising at least one prosthetic tooth (6) having a lumen (4) up to a solid body model (11), in which the at least one prosthetic tooth (6) is available without internal lumen (4), wherein the surface of said solid body model (11), in the cervical area of the respective tooth neck of the prosthetic teeth (6) without internal lumen (4), corresponds to a negative of the tooth-sided outer surface of the area (2.2) of the denture base (2), and at least one prosthetic tooth (6) is produced in a generative method.

8. The method according to claim 1, wherein in a method step (B), after performing step (viii) the at least one prosthetic tooth (6) having a lumen (4) or the prosthetic teeth (6) having at least one lumen up to respectively one lumen (4) per tooth, the at least one lumen (4) is filled up, at least in part, with a polymerisable, dental composition, optionally, the dental composition is polymerised at least in part,
and in a further method step
(ix) joining the at least one prosthetic tooth (6) and the denture base (9) into a dental prosthetic moulded part (5) ensues by mating together the at least one prosthetic tooth (6) with its cervical area to the corresponding tooth-sided areas (2.2) of the denture base, and
(x) the dental prosthetic moulded part (5) of a partial or total prosthesis is obtained.

9. The method according to claim 1, wherein
(ix) joining ensues by
a) mating together and, subsequently, the dental composition is polymerised,
b) gluing together,
c) melting together,
d) welding together and/or
e) shrinking together
the at least one prosthetic tooth (6) and the denture base (9) into a dental prosthetic moulded part (5).

10. The method according to claim 7, wherein,
(a) filling a polymerisable, dental composition in the lumen (4) of the at least one prosthetic tooth (6), and
(b) polymerising the composition, and, optionally, repeating steps a) and b), and
(c) joining the at least one prosthetic tooth (6), in the cervical area, to the corresponding tooth-sided areas (2.2) of the denture base (9),
or
(c) joining the at least one prosthetic tooth (6), in the cervical area, to the corresponding tooth-sided areas (2.2) of the denture base (9) and polymerising the composition,
wherein the at least one prosthetic tooth (6) is connected to the denture base (9) by mating and optionally polymerising.

11. The method according to claim 8, wherein the polymerisable, dental composition is a flowable, dentin-hued composition.

12. A prosthetic moulded part obtainable by a method according to claim 1.

13. Method of using a flowable, dentin-hued, polymerisable, dental composition comprising dental glasses in a method according to claim 1.

14. Method of using a total or partial prosthesis obtainable by the method according to claim 1 as (i) temporary prosthesis or (ii) as real model of a temporary prosthesis for adjusting the temporary prosthesis to the dental condition of the patient, or (iii) as real model of a temporary prosthesis for adjusting the temporary prosthesis to the dental condition of the patient and for scanning of the thus adjusted temporary prosthesis, as well as, optionally, for adjustment of the virtual model of the at least one prosthetic tooth (1) and the denture base (plate) (2) for generative production of the total or partial prosthesis of the patient.

15. The prosthetic moulded part according to claim 12, wherein the moulded part is at least one prosthetic tooth, partial/complete prosthetic dental arch, multilayered and/or multicoloured prosthetic tooth, multilayered and/or multicoloured partial/complete dental arch, denture base (plate) and/or total or partial prosthesis
